(19) United States
(12) Patent Application Publication
(10) Pub. No.: US 2007/0097246 A1
(43) Pub. Date: May 3, 2007

(54) Image capture device and method of capturing an image

(76) Inventor: Guy de Warrenne Bruce Adams, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/497,452

(22) Filed: Jul. 31, 2006

(30) Foreign Application Priority Data
Oct. 31, 2005 (GB) 0522224.5

(51) Int. Cl. H04N 5/222

(52) U.S. Cl. 348/333.01

(57) ABSTRACT

An image capture device (2) comprising: an input means (16, 300) arranged to allow a user to make an input to the device (2); a display (12) arranged to indicate at least one parameter associated with the capture of an image; wherein the input means (12, 300) is arranged to allow a user to control at least one parameter associated with the capture of the image and also to cause the image capture device (2) to capture an image.

### FIELD OF THE INVENTION

Embodiments of the invention relate to an image capture device and in particular, but not exclusively, to a hand held image capture device.

### BACKGROUND OF THE INVENTION

Image capture devices are generally constituted by cameras, whether digital or film based, but increasingly there are further devices, such as telephones, video cameras, and the like which are also used to capture images. Such devices generally have a single, image capture, button that is pressed by a user to determine when an image should be captured. Often, the image capture button has three positions: 1. Un-pressed (S0 mode); 2 half-pressed at which time device settings, such as focus, speed, exposure, etc. are set (S1 mode); and 3 fully-pressed at which time an image is captured (S2 mode).

### SUMMARY OF THE INVENTION

According to a first aspect of the invention there is provided an image capture device comprising:
an input means arranged to allow a user to make an input to the device;
a display arranged to indicate at least one parameter associated with the capture of an image;
wherein the input means is arranged to allow a user to control at least one parameter associated with the capture of the image and also to cause the image capture device to capture an image.

According to a second aspect of the invention there is provided a method of capturing an image using an image capture device comprising allowing a user to control a parameter associated with the capture of the image using an input means and subsequently causing the image capture device to capture the image to an image capture medium using the input means.

According to a third aspect of the invention there is provided a program arranged to control an image capture device arranged to allow a user to control a parameter associated with the capture of the image using an input means and subsequently to cause the image capture device to capture the image to an image capture medium using the same input means.

According to a fourth aspect of the invention there is provided a computer readable medium containing instructions providing the program according to the third aspect of the invention.

According to a fifth aspect of the invention there is provided a computer readable medium containing instructions which when loaded onto a processing apparatus cause that processing apparatus to function as the image capture device of the first or seventh aspects of the invention.

According to a sixth aspect of the invention there is provided a computer readable medium containing instructions which when loaded onto a processing apparatus cause that processing apparatus to provide the method of the second aspect of the invention.

According to a seventh aspect of the invention there is provided an image capture device comprising:
an image sensor arranged to sense an image of a subject and to generate a signal representative of the image;
a display arranged to receive the signal and to display the image of the subject;
an input means arranged to allow a user to make an input to the device; and
an image capture medium;
wherein, in use, the device is arranged to display the image of the subject on the display and allow a user to control, using the input means, one or more parameters associated with the capture of the image and subsequently allow a user to capture, using the input means, the image to the image capture medium.

According to an eighth aspect of the invention there is provided a method of capturing an image in which a user adjusts a parameter associated with the capture of the image using the same input means as is used to cause the image to be captured.

The computer readable medium of any of the above aspects of the invention may comprise any one of the following: a floppy disk, a CD ROM, a DVD ROM/RAM (including −R/−RW and +R/+RW), a memory, a hard drive, a magnetic tape, a memory (for example a memory card), a transmitted signal (such as an Internet download, an FTP download, or the like), a wire.

### BRIEF DESCRIPTION OF THE DRAWINGS

There now follows, by way of example only, a detailed description of the invention with reference to the accompanying drawings of which:

FIG. 1 shows schematically shows some components of image capture devices according to an embodiment of the invention;

FIG. 2 shows schematically a display generated on an image capture device which may be according to the prior art or according to an embodiment of the present invention;

FIG. 3 shows schematically how an input can be made to an input means of the image capture device of an embodiment of the invention;

FIG. 4 shows schematically a display generated on an image capture device according to an embodiment of the invention;

FIG. 5 shows schematically how an input can be made to an input means of the image capture device described in the embodiment shown in FIG. 4;

FIG. 6 shows schematically how the display on the image capture device is altered in response to the input to the input means detailed in FIG. 5;

FIG. 7 shows schematically how an input can be made to the input means in order to capture an image using the image capture device described in the embodiment shown in FIG. 4;

FIG. 8 shows schematically a display generated on an image capture device according to an embodiment of the invention, which may or may not be the embodiment of FIG. 4.

FIG. 9 shows schematically how an input can be made to an input means of the image capture device described in the embodiment shown in FIG. 8;

FIG. 10 shows schematically how the display on the image capture device is altered in response to the input to the input means detailed in FIG. 9;

FIG. 11 shows a flow chart detailing a method of using an image capture device according to an embodiment of the invention;

FIG. 12 shows schematically a display generated on an image capture device according to an embodiment of the invention, which may or may not be the embodiments shown in FIGS. 4 and 8;

FIG. 13 shows schematically how an input can be made to an input means of the image capture device described in the embodiment of FIG. 12;

FIG. 14 shows schematically how the display on the image capture device is altered in response to the input to the input means detailed in FIG. 13; and

FIG. 15 shows schematically the arrangement of an input means and a display on an image capture device.

### DETAILED DESCRIPTION OF THE DRAWINGS

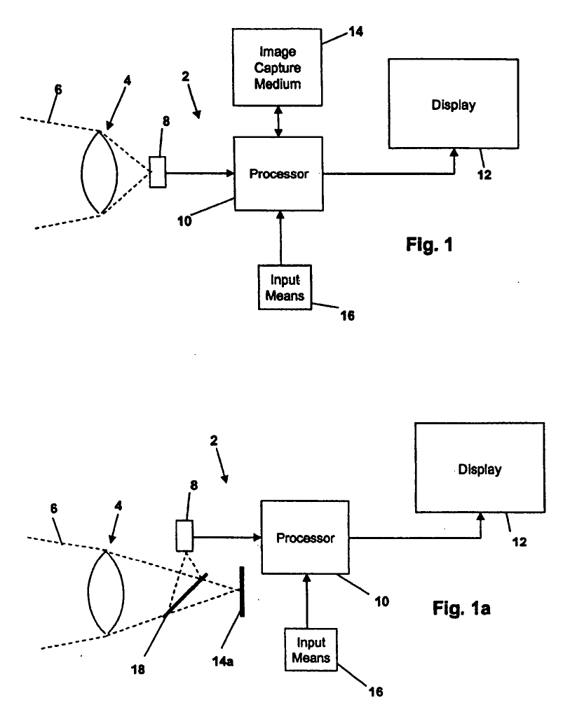

FIG. 1 shows some of the components of an image capture device 2 according to an embodiment of the invention. The image capture device may typically be a camera but could equally be a Personal Digital Assistant (PDA), telephone, Video Camera (which may capture a series of images as a video stream or a single image), Digital music player (such as an MP3 player), portable computer (such as a notebook, laptop, etc.), or the like.

The device comprises a lens and shutter arrangement 4 arranged to focus incident light 6 upon an image sensor 8. Generally, the image sensor comprises a Charge Coupled Device (CCD array) but may be any other suitable image sensor.

The image capture device also comprises apparatus to focus and control the exposure time of the shutter arrangement 4 and image sensor 8 but, because these are well understood in the art, will not be described further.

The image sensor 8 converts the incident light 6 focused on to it into an electronic signal representative of the image that is captured which can be read and processed by processing circuitry. In this embodiment the processing circuitry is provided by a processor 10, although this need not be the case. In other embodiments the processing circuitry may be provided by hardwired circuitry which may include, or be constituted by, an Application Specific Integrated Circuit (ASIC), microcontroller, or the like.

The processor 10 is arranged to receive the signal representative of the image and cause the signal to be displayed on a display 12 which generates a representation of the image falling upon the image sensor 8; i.e. the image that would be captured by the image capture device if it were instructed to capture an image at that instant. The display may typically be a Liquid Crystal Display (LCD) but could equally be any other suitable form of display, such as a Light Emitting Polymer (LEP) display, or the like.

In some embodiments of the invention the display 12 may not display the image sensed by the image sensor 8 and may simply be arranged to display an indication of at least one parameter associated with a capture of an image. For example, the display may be an LCD, LED (Light Emitting Diode) or the like, showing a bar-graph indicator which provides an indication of the parameter such as the level of zoom.

The processor 10 is also connected to an image capture medium 14. In the embodiment being described the image capture medium 14 is a memory which may typically be provided by a memory card, disk drive or the like. For example, the image capture medium may be any one or more of the following: an SD card, a Compact Flash card, a Memory Stick™, a PCMCIA device (such as a disk drive), or the like. The image capture medium 14 need not be removable from the image capture device 4 where this is convenient for a user.

An input means 16, which is described in more detail below, provides an input to the processor 10 and may be used to control capture of an image onto the image capture medium 14 as well as to control one or more parameters associated with the capture of the image.

FIG. 1a shows a modification to the embodiment shown in FIG. 1 in which the image capture medium 14a may comprise film (for example 35 mm film) as well as being a memory or the like. In this embodiment the image capture device is shown as being, what is commonly referred to as, a Single Lens Reflex (SLR) device; i.e. the viewfinder used by a user is what is captured on the image capture medium 14a. It is not however, necessary for the device 2 to be an SLR device. The embodiment of FIG. 1a therefore comprises a mirror 18 which can occupy the position shown in the Figure such that light incident upon it is directed toward the image sensor 8 or be moved out of the way to allow light to be incident upon the image capture medium 14a.

It will be appreciated that the image captured in the embodiment of FIG. 1a is not the image captured by the image sensor 8 whereas in the embodiment of FIG. 1 the image captured is the image captured by the image sensor 8. The skilled person will be able to appreciate many other ways of achieving these ends.

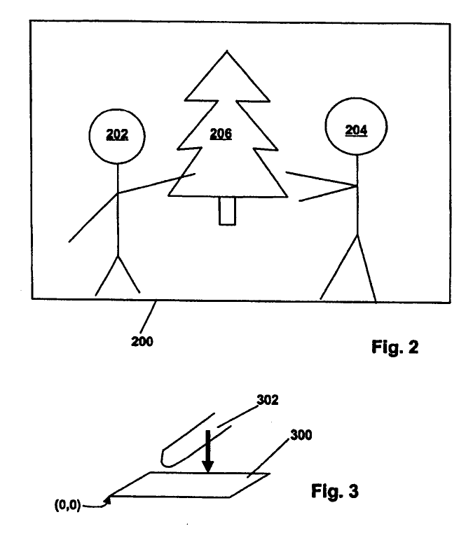

FIG. 2 schematically shows an image 200 which is incident upon the image sensor 8 and is subsequently displayed on the display 12 in order that it can be viewed by a user of the image capture device 2. The schematic image is made of up two people 202, 204 in the foreground and a tree 206 in the background of the image.

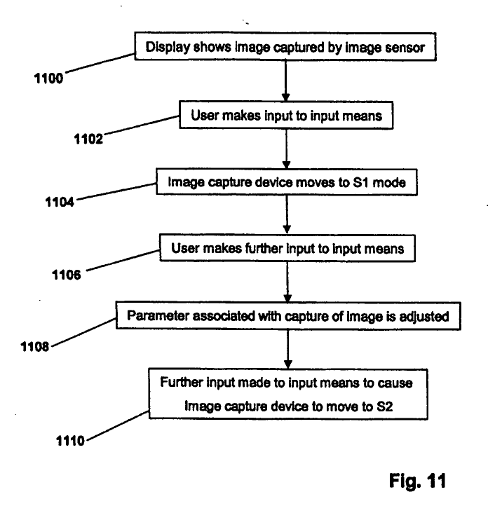

FIGS. 3 to 7 show how one embodiment of the invention may be used to capture the image shown in FIG. 2. FIG. 11 is a flowchart which shows a method of using one embodiment of an image capture device.

FIG. 3 shows an example of an input means 16. In this embodiment the input means 16 comprises a track pad 300, similar (but typically smaller than) those found on notebook or laptop computers. As such, the track pad provides an input to the processor 10 which provides an XY co-ordinate of pressure applied to the track pad. The reference frame for the XY coordinate system is arbitrary but for the sake of ease of reference it is convenient to take the origin of co-ordinate system as the bottom left corner of the track pad 300 (as shown in the Figure).

In other embodiments the input means may be provided by other mechanisms. For example any of the following may be suitable and are intended to be examples only of the mechanisms that may be used to provide the input means 16: a group of switches, a joystick, a rollerball, optical tracking means of the fingertip (similar to an inverted optical mouse), or any other suitable mechanism. In some embodiments, the input means may comprise a plurality of mechanism, such as plurality of switches. For example, a switch may be provided for a plurality of a users fingers. A possible advantage of such an input means is that the user may be able to make a plurality of inputs to the capture device and thus be able to control more functionality

Whilst no pressure is applied to the track pad 300 the image capture device 2 remains in what is generally referred to as S0 mode; i.e. the camera does not focus and simply displays on the display 12 an image generated by the image sensor 8. The S0 mode allows a user to line up a picture that he/she wishes to capture using the image capture device 2. Box 1100 of FIG. 11 represents the image capture device being in the S0 mode.

When the user sees a picture that he/she wishes to capture using the image capture device 2 he/she can place his/her finger 302 on the track pad 300 (box 1102 in FIG. 11). The pressure generated by the finger 302 causes the track pad 300 to generate an XY co-ordinate which is passed to the processor 10. Once the processor receives such an XY co-ordinate it enters what is generally referred to as S1 mode as shown by box 1104 in FIG. 11; i.e. the image capture device causes the lens and shutter arrangement 4 to focus.

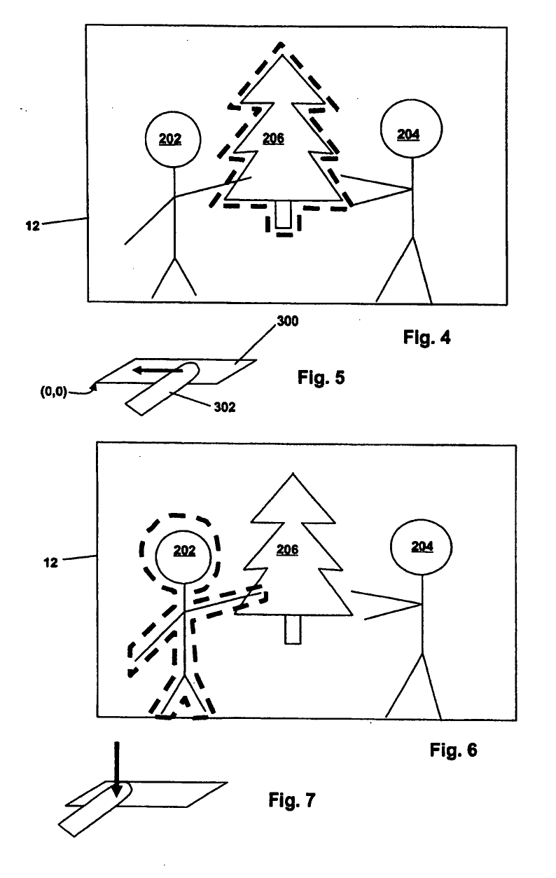

As discussed in relation to FIGS. 1 and 1a the processor 10 is arranged to receive the signal generated by the image sensor 8, process it and to cause the image to be shown on the display 12. In this embodiment, the processing includes identifying, using an appropriate algorithm on an object within the image on which the lens and shutter arrangement 4 is currently being focused and further, to mark that object on the display so that it is apparent to a user. A description of such an algorithms can be found at the web site http://www.cs.washington.edu/research/imagedatabase/. In the embodiment shown in FIG. 4 it can be seen that the processor is indicating (via the broken line) that the image capture device 2 is being caused to focus on the tree 206.

The user may desire that the image capture device focuses on an object other than the object initially selected by the image capture device 2; i.e. the tree 206. In the example being described in relation to FIG. 2, it is perhaps unlikely that the user would want the tree 206 in focus, but the people 202, 204 out of focus. The embodiment being described allows a user to specify, by making an appropriate input via the track pad 300, that the image capture device 2 should focus on a different object; i.e. the user makes a further input to the input means as represented by box 1106 of FIG. 11.

In some embodiments of the invention the processor may be arranged to track the object which has been selected for focus and to maintain that object in focus as a user moves the image capture device.

It may be advantageous for the image capture device to highlight which object is in focus due to a lower number of pixels in the display 12 when compared to the image that is captured by the image capture medium 14, 14a. As such, it may be difficult for a user to see from the display 12 whether or not the desired object is in focus.

The processor may be arranged to highlight more than one object if more than one object is in focus. For example, if both of the people 202, 204 are in focus then both of them may be highlighted.

Referring to FIG. 5, a user's finger 302, which is now in contact with the track pad 300, is being moved (with reference to the Figure) in a right to left direction. This motion can be determined by the processor 10 in view of the decreasing X co-ordinate generated by the track pad 300 and the processor is programmed to interpret this motion as indicating that the image capture device 2 should be caused to focus on an object to the left of the object currently in focus (i.e. the tree 206). In the example given in FIG. 4 this object is the person 202. Likewise if the user had moved his/her finger 302 in a left to right direction the image capture device would have been caused to focus on the object to the right of the image currently in focus; i.e. the person 204.

Thus, a parameter associated with the capture of an image has been adjusted as represented by box 1108 of FIG. 11. As such, the embodiment provides an image capture device which may be more convenient to use than prior art image capture devices because it allows a user to adjust capture of the image using the same input means as is used to capture the image.

As the image capture device 2 is caused to refocus on the person 202, the processor 10 causes the display 12 to show the object that is currently in focus. In this embodiment this is achieved by the outlining the person 202 with the broken line. That is, the display is updated to indicate how the parameter associated with the capture of image changes as a user makes an input to the input means.

In this embodiment, once the user sees that the image capture device has focused on the person 202 he/she is happy that the image should be captured to the image capture medium 14, 14a and applies more pressure to the track pad 300 which senses this input and produces a corresponding output. Alternatively this increase in pressure is sensed by other means e.g. a switch under or otherwise associated with the track pad assembly. (represented by box 1110 of FIG. 11). This further pressure is detected by the processor 10 in the data generated by the track pad 300/switch input and the processor therefore causes the image to be captured to the image capture medium 14, 14a. This extra pressure to cause an image to be captured is often referred to as S2 mode in the art; i.e. the image is captured. A switch associated with the track pad, or other input means, may work in a similar manner to a switch associated with the wheel of a wheel mouse.

Once the image has been captured the image capture device 2 is arranged to return to the S0 mode (or indeed the S1 mode, or other mode). Thus, the embodiment described in relation to FIGS. 3 to 7 shows a image capture device that allows a user to control the focus of the device using the track pad 300 (i.e. the input means). The focus of the device may be thought of as a parameter associated with the capture of an image by the image capture device.

In this embodiment, if the user desired to move from the S1 mode back to the S0 mode without capturing an image then he/she can remove his/her finger from the track pad 300.

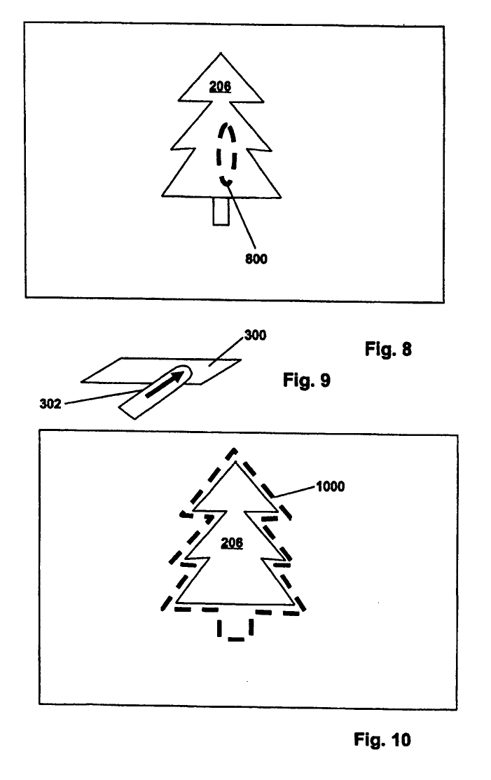

FIGS. 8 to 10 describe a further use of an input means to control a parameter associated with the capture of an image by an image capture device which may be provided by the embodiment described in relation to FIGS. 3 to 7 or by a separate embodiment.

In the embodiment being described in relation to FIGS. 8 to 10 allow a user can control the depth of focus of the device. As in FIG. 3, the display 12 shows an image as seen by the image sensor 8 and which would be captured if a user were to capture to the image capture medium 14, 14a. The processor 10 causes an area that is currently in focus to be highlighted by adding a broken line 800 to the display.

It can be seen, as represented in FIG. 8, that the depth of focus is such that only a small portion of the tree and not the whole tree is in focus. Again, it is convenient to refer to the input means as a track pad 300 and FIG. 9 shows a user's finger 302 on the track pad. For convenience it is assumed that the image capture device is already in the S1 mode.

The user moves his/her finger 302 in an upward direction (as represented in the Figure) thus causing an increasing Y value to be generated and fed to the processor 10. On such an input the processor 10 is programmed to cause the image capture device 2 to increase its depth of focus.

The result of this increase of depth of focus is shown in FIG. 10 wherein the image capture device is highlighting the whole of the tree 206. A user may capture an image to the image capture medium 14, 14a by applying further pressure to the track pad 16.

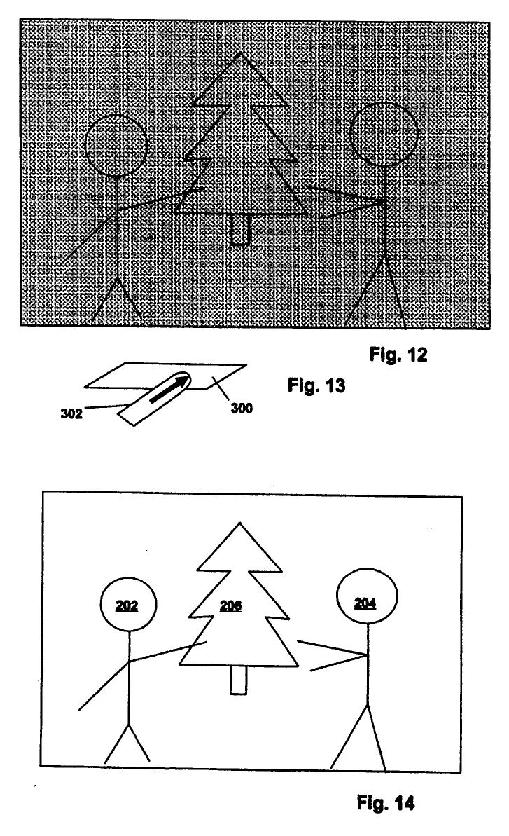

FIGS. 12 to 14 describe a further use of an input means to control a parameter associated with the capture of an image by an image capture device which may be provided by the embodiment described in relation to FIGS. 3 to 7, FIGS. 8 to 10 or by a separate embodiment.

In the embodiment being described in relation to FIGS. 12 to 14 allow a user to control the exposure of an image captured by the image capture device 2. As in FIG. 3, the display shows an image as seen by the image sensor 8 and which would be captured if a user were to capture to the image capture medium 14, 14a. It is assumed that the image capture device is in the S1 mode and thus the display 12 shown in FIG. 12 represents an image that would be captured. It can be seen that the setting for the capture is under exposed and thus the image would appear too dark if it were captured to the image capture medium 14, 14a.

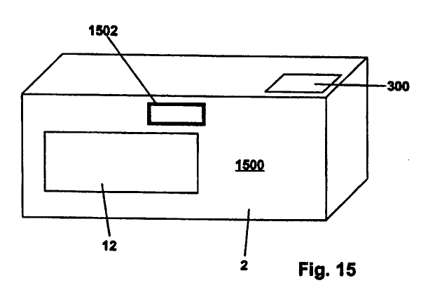

In this embodiment a user may use the input means 300 to control the exposure of the image capture by the image capture device. As can be seen in FIG. 13 the processor is arranged to take an increasing Y value in the co-ordinates generated by the track pad 300 as an indication that the exposure of the image capture should be increased. The result of this movement of the user's finger 300 (as shown in FIG. 13) is represented in FIG. 14 in which it can be seen that the image has been lightened. Again, the image capture device 2 can be made to move to the S2 mode by further pressure being applied to the track pad 300.

Embodiments have been described above in which a user of the image capture device can adjust various parameters (focus, depth of focus, exposure) of the image capture. These are given by way of example only and any other parameter may be adjusted by appropriate use of the input means. For example, a user may be able to adjust any of the following parameters: shutter speed; speed of the image capture medium, zoom level of the image capture device, whether the image is black & white, colour, sepia, etc. (i.e. the colour of), the colour balance, or the like.

In some embodiments of the invention a user may be able to select, perhaps using a set up menu of the device, or the input means, which parameter of the image capture is to be controlled using the input means.

It is known in the prior art of cameras to provide a mechanism to cause the camera to capture an image on a top surface of the camera toward an edge region thereof. As such it is convenient for a user to hold the camera with one hand and to use an index finger to operate the mechanism.

FIG. 15 shows the rear view of an image capture device which is a camera 1500 in the embodiment being described. A rear face of the camera 1500 is shown in the Figure and the display 12 together with an optical view finder 1502 can be seen in the Figure. A track pad 300 is provided on a top surface of the camera 1500 toward an edge region thereof, in a similar position to that the mechanism used in the prior art to cause a camera to capture an image. Should the input means be provided in such a position it may be convenient to arrange the input means such that the parameter associated with the capture of the image can be adjusted by an extension/contraction of a user's finger rather than a side to side motion. Such an extension/contraction is likely to be more convenient to a user when compared to a side to side motion.

The location of the input means on the upper surface of the camera is shown only as an example and other locations may be equally possible.

In the embodiments described above, it has been described that the image capture device moves from S0 mode, through S1 mode to S2 mode. This is not essential to the invention and other modes may be possible.

In embodiments described above, it has been described that a user may apply further pressure to the track pad 300 in order to cause the image capture device to capture an image. This is not essential to the invention and other inputs may be equally possible to cause an image to be captured. For example, a user may be able to make a ‘double click’ (i.e. two presses within a predetermined time); may be able to hold his/her finger still for a predetermined time; may be able to move his/her finger in a direction transverse a direction of movement required to adjust the parameter. If an input means other than a track pad is used then other inputs, which may be specific to that form of input means, may be used in order to cause the image capture device to capture an image.

In some embodiments is may be possible for the input means to allow a user to adjust more than one parameter associated with the capture of the image. For example, if the input means were a track pad then X direction may be used to control a first parameter and the Y direction may be used to control a second parameter. Other input mechanisms may allow a different number of parameters to be controlled.

1. An image capture device comprising:
an input means arranged to allow a user to make an input to the device;
a display arranged to indicate at least one parameter associated with the capture of an image;
wherein the input means is arranged to allow a user to control at least one parameter associated with the capture of the image and also to cause the image capture device to capture an image.

2. A device according to claim 1 in which the display is arranged to display an image as detected by an image sensor of the image capture device.

3. A device according to claim 1 in which the device is arranged to capture an image to an image capture medium comprising any one of the following: a memory or other machine readable medium, a film.

4. A device according to claim 1 in which the input means comprises any one of the following: a track pad, a roller ball, a joystick, an optical tracking means, one or more swtiches.

5. A device according to claim 1 in which is any one of the following: a camera, a telephone, a video camera, a Personal Digital Assistant (PDA), a notebook/laptop computer, a portable music/video player.

6. A device according to claim 1 in which the input means allows a plurality of parameters to be controlled.

7. A device according to claim 1 in which one or more portions of the input means is provided in a region at which the device is arranged for a user to place a digit.

8. A device according to claim 1 in which the parameter is any one or more of the following: focus, depth of focus, exposure, shutter speed; speed of the image capture medium, zoom level, the colour balance, whether the image is in colour.

9. A device according to claim 1 in which the device is arranged to allow a user to specify which parameter can be controlled by the input means.

10. A method of capturing an image using an image capture device comprising allowing a user to control a parameter associated with the capture of the image using an input means and subsequently causing the image capture device to capture the image to an image capture medium using the input means.

11. A method according to claim 10 which comprises displaying an image generated by a sensor of the image capture device on a display and indicating on the display an indication of the parameter.

12. A program arranged to control an image capture device arranged to allow a user to control a parameter associated with the capture of the image using an input means and subsequently to cause the image capture device to capture the image to an image capture medium using the same input means.

13. A computer readable medium containing instructions providing the program according to claim 12.

14. A method of capturing an image in which a user adjusts a parameter associated with the capture of the image using the same input means as is used to cause the image to be captured.

15. A method according to claim 10 which allows any one or more of the following parameters to be adjusted: focus, depth of focus, exposure, shutter speed; speed of the image capture medium, zoom level, the colour balance, whether the image is in colour.

16. A method of capturing an image using an image capture device comprising the steps of:
operating a user interface on the image capture device by entering one or more image characteristic inputs to control one or more parameters relating to capture of the image by the device;
detecting the occurrence of a second, image-capture input from the user interface; and
upon detection of the second input, capturing an image in accordance with the or each parameter as determined by the or each image characteristic input from the user interface.

17. A method according to claim 16, wherein the first inputs include:
focus, depth of focus, exposure, shutter speed; speed of the image capture medium, zoom level, the colour balance, whether the image is in colour.
